(19) United States
(12) Patent Application Publication
(10) Pub. No.: US 2020/0137721 A1
(43) Pub. Date: Apr. 30, 2020

(54) IoT BASE STATION AND RESOURCE ARRANGMENT METHOD THEREOF

(71) Applicant: Institute For Information Industry, Taipei (TW)

(72) Inventors: Li-Sheng CHEN, Yilan County (TW); Chi-Hsien KAO, Taipei City (TW); Chin-Gwo MA, New Taipei City (TW)

(21) Appl. No.: 16/203,603

(22) Filed: Nov. 28, 2018

(30) Foreign Application Priority Data
Oct. 26, 2018 (CN) 201811258305.7

(51) Int. Cl. H04W 72/02; H04W 72/04; H04W 4/80; H04W 4/70

(52) U.S. Cl. CPC H04W 72/02; H04W 72/048; H04W 4/70; H04W 4/80; H04W 72/042

(57) ABSTRACT

An IoT base station and a resource arrangement method thereof are provided. For each of a plurality of candidate resource arrangement orders of a plurality of user equipments in a downlink shared channel, the IoT base station calculates a resource waste of every two adjacent user equipments. Each of the resource wastes is calculated based on a basic delay, the two end positions of the downlink control information of the two user equipments in a downlink control channel, an additional delay of each of the two user equipments, and the resource demand of the former one of the two user equipments. Each of the candidate resource arrangement orders corresponds to a total resource waste. The IoT base station selects the candidate resource arrangement order corresponding to the minimum total resource waste as a selected resource arrangement order.

### PRIORITY

This application claims priority to Chinese Patent Application No. 201811258305.7 filed on Oct. 26, 2018, which is hereby incorporated by reference in its entirety.

### FIELD

The present invention relates to an Internet of Things (IoT) base station and a resource arrangement method thereof. More particularly, the present invention relates to an IoT base station and a resource arrangement method thereof that arrange downlink resources for a plurality of user equipments.

### BACKGROUND

Many IoT communication standards (e.g., the Narrow Band Internet of Things (NB-IoT) standard specified by the 3^{rd} Generation Partnership Project Agreement (3GPP), the Massive Machine-Type Communication (Massive MTC) standard in the 5^{th} generation of mobile communication system or the like) have specific requirement in arranging downlink resources for a plurality of user equipments. FIG. 1 illustrates an architecture of a downlink processing period 10 of a conventional IoT communication standard, which comprises a downlink control channel 12 for transmitting control signals and a downlink shared channel 14 for transmitting data. In the NB-IoT standard, the downlink control channel 12 is a narrow band physical downlink control channel (NPDCCH), while the downlink shared channel 14 is a narrow band physical downlink shared channel (NPDSCH).

An IoT base station that adopts the conventional technology provides services for user equipments on a first come, first served basis. For convenience, it is assumed that the IoT base station provides services for four user equipments in the downlink processing period 10, wherein the four user equipments are arranged in the order of a first user equipment, a second user equipment, a third user equipment, and a fourth user equipment. The IoT base station arranges the downlink control information (DCI) C₁, C₂, C₃, and C₄ of the first user equipment, the second user equipment, the third user equipment, and the fourth user equipment in the downlink control channel 12 in sequence on the first come, first served basis, wherein the downlink control information C₁, C₂, C₃, and C₄ respectively correspond to the end positions n₁, n₂, n₃, and n₄.

Next, the IoT base station arranges transmission resources for the first user equipment, the second user equipment, the third user equipment, and the fourth user equipment in the downlink shared channel 14 in sequence on the first come, first served basis. Specifically, for any of the user equipments, the IoT base station determines the start position of the transmission resource of the user equipment in the downlink shared channel 14 according to the end position of the downlink control information of the user equipment, a basic delay, and an additional delay of the user equipment and then arranges the transmission resource of the user equipment in the downlink shared channel 14 according to the start position and the resource demand of the user equipment. Please note that many IoT communication standards have specific requirement on the basic delay and additional delays. Taking the NB-IoT standard as an example, the basic delay specified by the NB-IoT standard is a value of 5 and each additional delay must be selected from a preset group (specifically, the preset group comprises specific values, including 0, 4, 8, 16, 32, 64, 128, 256, . . . ) Please noted that the transmission resources arranged by the IoT base station for the first user equipment, the second user equipment, the third user equipment, and the fourth user equipment cannot overlap with each other.

Taking the first user equipment as an example, the IoT base station selects a value from the preset group as an additional delay k₀¹, sums up the end position n₁, the basic delay (i.e., the value 5), and an additional delay k₀¹ as a start position s₁ (i.e., n₁+5+k₀¹) of the transmission resource of the first user equipment in the downlink shared channel 14, and arranges a transmission resource D₁ according to the start position s₁ and the resource demand of the first user equipment. Taking the second user equipment as another example, the IoT base station selects a value from the preset group as an additional delay k₀¹ of the second user equipment, sums up the end position n₂, the basic delay (i.e., the value 5), and an additional delay k₀² as a start position s₂ (i.e., n₂+5+4²) of the transmission resource of the second user equipment in the downlink shared channel 14, and arranges a transmission resource D₂ according to the start position s₂ and the resource demand of the second user equipment. The additional delay k₀² selected by the IoT base station for the second user equipment must satisfy the requirement that the start position s₂ will not fall within the transmission resource D₁ of the first user equipment (i.e., satisfy the requirement that the transmission resource D₁ and the transmission resource D₂ will not overlap). Based on similar operation principle, the IoT base station will select an additional delay k₀³, calculate a start position s₃, and then arrange a transmission resource D₃ for the third user equipment. Likewise, the IoT base station will select an additional delay k₀⁴, calculate a start position s₄, and then arrange a transmission resource D₄ for the fourth user equipment.

As mentioned, the conventional IoT base station arranges transmission resources in the downlink shared channel 14 for the user equipments on the first come, first served basis. The additional delay of each of the user equipments must be selected from a preset group and the transmission resources arranged for the user equipments cannot overlap with each other. With these restrictions, the resource arrangement result of the conventional technology often causes many resource gaps in the downlink shared channel 14 and is very likely to exceed the current downlink processing period 10 (e.g., the transmission resource D₄ of FIG. 1 exceeds the downlink processing period 10) and thus cause huge resource waste.

Accordingly, there is still an urgent need for a resource arrangement technology that can sufficiently utilize resource of the downlink shared channel.

### SUMMARY

Provided are an Internet of Things (IoT) base station and a resource arrangement method thereof.

The IoT base station can comprise a transceiver and a processor electrically connected with the transceiver. The processor is configured to arrange a plurality of downlink control information corresponding to a plurality of user equipments respectively in a downlink control channel, wherein each of the downlink control information corresponds to an end position and each of the user equipments has a resource demand. For each of a plurality of candidate resource arrangement orders of the plurality of user equipments in a downlink shared channel, the processor further calculates a resource waste of every two adjacent user equipments, wherein each of the resource wastes is calculated based on a basic delay, the two end positions of the two user equipments corresponding to the resource waste, an additional delay of each of the two user equipments corresponding to the resource waste, and the resource demand of the former user equipment of the two user equipments corresponding to the resource waste. Each of the candidate resource arrangement orders corresponds to a total resource waste, wherein each of the total resource wastes is a sum of the resource wastes of the corresponding candidate resource arrangement order. The processor further selects the candidate resource arrangement order corresponding to the minimum total resource waste as a selected resource arrangement order. The transceiver further transmits a plurality of data respectively corresponding to the plurality of user equipments according to the selected resource arrangement order.

The resource arrangement method is adapted for use in an Internet of Things (IoT) base station. The resource arrangement method can comprise the following steps (a)-(d). The step (a) arranges a plurality of downlink control information corresponding to a plurality of user equipments respectively in a downlink control channel, wherein each of the downlink control information corresponds to an end position and each of the user equipments has a resource demand, In the step (b), for each of a plurality of candidate resource arrangement orders of the plurality of user equipments in a downlink shared channel, the resource arrangement method calculates a resource waste of every two adjacent user equipments, wherein each of the resource wastes is calculated based on a basic delay, the two end positions of the two user equipments corresponding to the resource waste, an additional delay of each of the two user equipments corresponding to the resource waste, and the resource demand of the former user equipment of the two user equipments corresponding to the resource waste. Each of the candidate resource arrangement orders corresponds to a total resource waste and each of the total resource wastes is a sum of the resource wastes of the corresponding candidate resource arrangement order. The step (c) selects the candidate resource arrangement order corresponding to the minimum total resource waste as a selected resource arrangement order. The step (d) transmits a plurality of data respectively corresponding to the plurality of user equipments according to the selected resource arrangement order.

The resource arrangement technology (including the IoT base station and the resource arrangement method thereof) provided herein can evaluate the total resource waste of each of the plurality of candidate resource arrangement orders of the plurality of the user equipments in the downlink shared channel before arranging the transmission resources of the downlink shared channel for the user equipments. During the evaluation of each of the candidate resource arrangement orders, the resource arrangement technology provided by the present invention will individually determine the additional delay for each user equipment which minimize the resource wastes of the candidate resource arrangement order. Then, the resource arrangement technology provided by the present invention will select the candidate resource arrangement order corresponding to the minimum total resource waste as the selected resource arrangement order to be adopted. By considering the total resource waste of each of the candidate resource arrangement orders, the resource arrangement technology provided herein can sufficiently use the resources of the downlink shared channel Hence, the amount of resource waste can be reduced and the probability that the transmission resource demands of all the user equipments cannot be arranged within one downlink processing period can be decreased.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates an architecture of a downlink processing period 10 of a conventional IoT communication standard;

FIG. 2A illustrates a schematic view of an IoT base station 2 in the first embodiment of the present invention;

FIG. 2B illustrates an architecture of a downlink processing period 20 adopted by the IoT base station 2;

FIG. 2C illustrates all the candidate resource arrangement orders that can be formed by user equipments U1, U2, U3, and U4;

FIG. 2D illustrates the resource wastes corresponding to the six candidate resource arrangement orders starting from the user equipment U1;

FIG. 2E illustrates an exemplary matrix after row operations;

FIG. 2F illustrates an exemplary matrix after column operations;

FIG. 2G illustrates an exemplary matrix after being evaluated according to the operation (d); and

FIG. 3 depicts a flowchart of a resource arrangement method according to a second embodiment of the present invention.

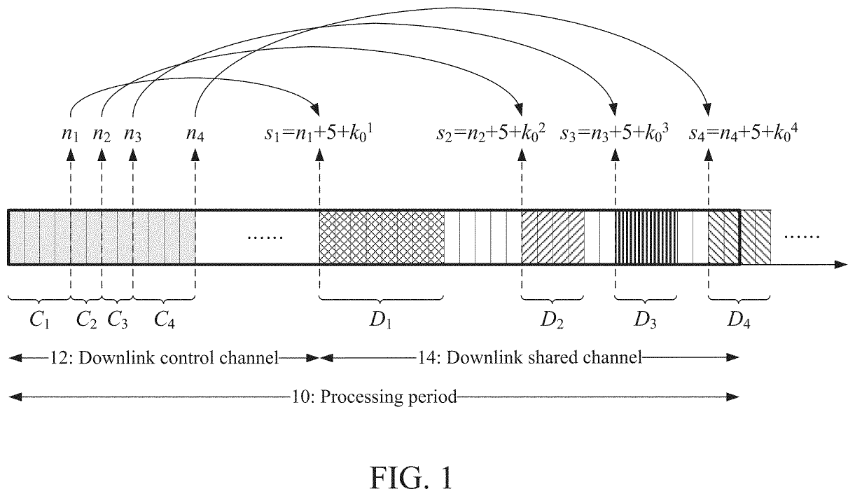

### DETAILED DESCRIPTION

In the following description, an IoT base station and a resource arrangement method thereof will be explained with reference to certain example embodiments thereof. However, these example embodiments are not intended to limit the present invention to any particular example, embodiment, environment, applications, or implementations described in these example embodiments. Therefore, description of these example embodiments is only for purpose of illustration rather than to limit the scope of the present invention.

It shall be appreciated that, in the following embodiments and the attached drawings, elements unrelated to the present invention are omitted from depiction; and dimensions of individual elements and dimensional relationships between individual elements in the attached drawings are provided only for illustration, but not to limit the scope of the present invention.

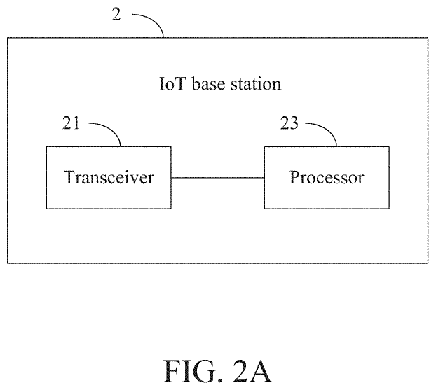

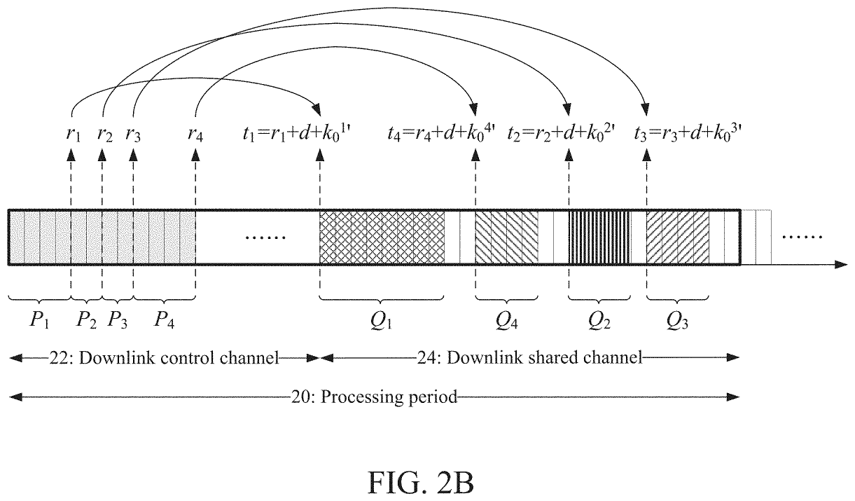

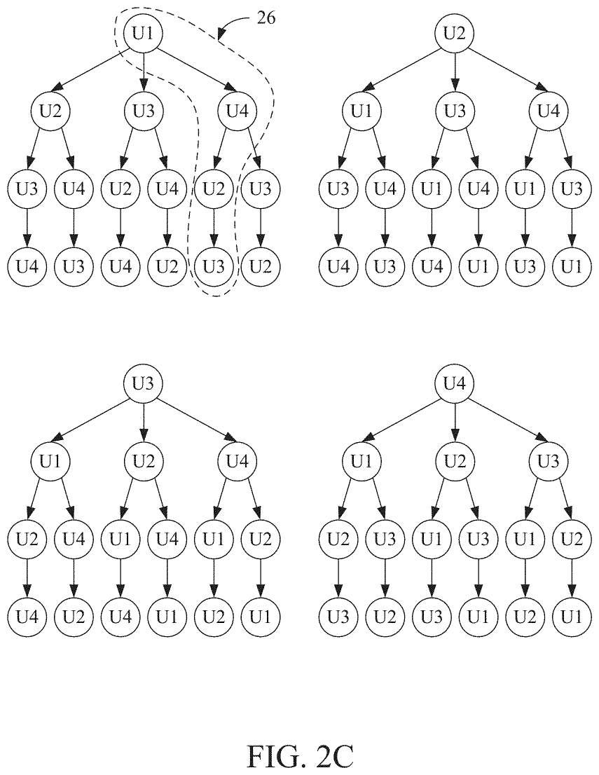

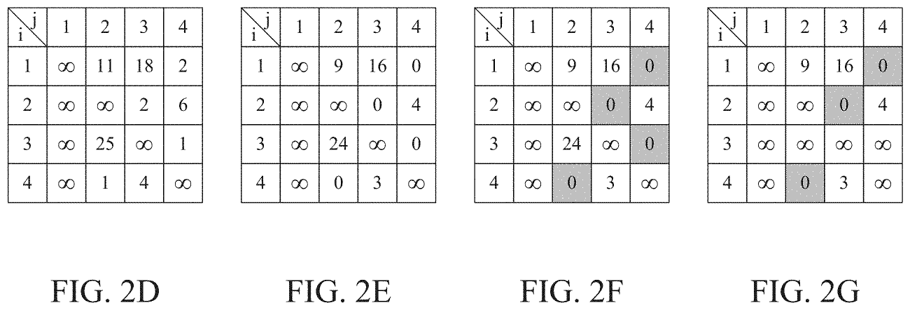

Please refer to FIG. 2A to FIG. 2G for a first embodiment of the present invention. FIG. 2A illustrates a schematic view of an IoT base station 2 in the first embodiment. The IoT base station 2 comprises a transceiver 21 and a processor 23, wherein the transceiver 21 and the processor 23 are electrically connected with each other. The transceiver 21 may be any interface that is capable of communicating with user equipment(s). The processor 23 may be one of various processors, central processing units (CPUs), microprocessors, digital signal processors (DSPs), or any other computing devices with the similar functions and well-known to those of ordinary skill in the art.

The IoT base station 2 may adopt any of various IoT communication standards, e.g., a Narrow Band Internet of Things (NB-IoT) standard specified by the 3^{rd} Generation Partnership Project Agreement (3GPP), and a Massive Machine-Type Communication (Massive MTC) standard in a 5^{th} generation of mobile communication system. FIG. 2B illustrates an architecture of a downlink processing period 20 adopted by the IoT base station 2, wherein each small rectangle in FIG. 2B represents a resource unit. The downlink processing period 20 comprises a downlink control channel 22 for transmitting control signals and a downlink shared channel 24 for transmitting data. If the IoT base station 2 adopts the NB-IoT standard, the downlink control channel 22 is a narrow band physical downlink control channel (NPDCCH) and the downlink shared channel 24 is a narrow band physical downlink shared channel (NPDSCH).

In this embodiment, the IoT base station 2 provides services for four user equipments U1, U2, U3, and U4 in the downlink processing period 20. Please note that the number of the aforesaid user equipments is only an example. The present invention does not limit the number of the user equipments that the IoT base station 2 can provide service in one downlink processing period 20 to any specific number.

In this embodiment, the user equipments U1, U2, U3, and U4 all require resources for downlink transmission. The processor 23 arranges downlink control information P₁, P₂, P₃, and P₄ of the user equipments U1, U2, U3, and U4 respectively in the downlink control channel 22. When arranging the downlink control information of a user equipment, the processor 23 may decide the number of repetitions of the user equipment by taking the communication quality between the IoT base station 2 and the user equipment into consideration. In this embodiment, the number of repetitions decided by the processor 23 for the user equipments U1, U2, U3, and U4 are 4, 2, 2, and 4 respectively. Therefore, the downlink control information P₁, P₂, P₃, and P₄ arranged by the processor 23 in the downlink control channel 22 have 4, 2, 2, and 4 resource units respectively. The downlink control information P₁, P₂, P₃, and P₄ correspond to the end positions r₁, r₂, r₃, and r₄ in the downlink control channel 22 respectively. Please note that the way that the IoT base station decides the number of repetitions of the user devices U1, U2, U3, and U4 is not the focus of the present invention and shall be appreciate by those of ordinary skill in the art and, thus, will not be further described herein.

Each of the user equipments U1, U2, U3, and U4 has a resource demand. In some embodiments, the processor 23 may calculate the resource demand of each of the user equipments U1, U2, U3, and U4 according to a demand number of resource units (i.e., the number of the resource units required) and the number of repetitions corresponding to each of the user equipments U1, U2, U3, and U4 (e.g., by multiplying the demand number of the resource units by the number of repetitions). For example, the demand numbers of the user equipments U1, U2, U3, and U4 are 2, 2, 2, and 1 respectively, the numbers of repetitions defined by the downlink control information of the user equipments U1, U2, U3, and U4 are 4, 2, 2, and 4 respectively, and the processor 23 derives the resource demands of the user equipments U1, U2, U3 and U4 by multiplying the demand numbers of resource units of the user equipments U1, U2, U3, and U4 by the numbers of repetitions of the user equipments U1, U2, U3 and U4, which are 8, 4, 4, and 4 respectively.

In this embodiment, the processor 23 will evaluate a plurality of candidate resource arrangement orders of the user equipments U1, U2, U3, and U4 in the downlink shared channel 24. FIG. 2C illustrates all the candidate resource arrangement orders that can be formed by the user equipments U1, U2, U3, and U4. In this embodiment, the processor 23 will evaluate all the candidate resource arrangement orders. In other embodiments, the processor 23 may only evaluate a portion of the candidate resource arrangement orders.

Specifically, for each of the candidate resource arrangement orders, the processor 23 calculates a resource waste of every two adjacent user equipments. Each of the resource wastes is calculated based on a basic delay, the two end positions of the two user equipments corresponding to the resource waste, an additional delay of each of the two user equipments corresponding to the resource waste, and the resource demand of the former user equipment of the two user equipments corresponding to the resource waste. If the IoT base station 2 adopts the NB-IoT standard, the basic delay is a value of 5 and each additional delay must be selected from a preset group (specifically, the preset group comprises specific values, including 0, 4, 8, 16, 32, 64, 128, 256, . . . ). For example, the processor 23 may calculate each of the resource wastes according to the following equation (1). It shall be noted that the processor 23 selects a specific value from the preset group as the variant k₀ⁱ in a way that the variant k₀ⁱ makes the variant AGₘⁱ larger than 0 when calculating each of the resource wastes according to the following equation (1). In some embodiments, the processor 23 selects more than one specific value from the preset group values as candidates of the variant k₀ⁱ in a way that the candidate(s) make the variant AGₘⁱ not smaller than 0 and then selects the smallest candidate as the variant k₀ⁱ.

AGₘⁱ=(nᵢ+d+k₀ⁱ)−(nᵢ₋₁+d+k₀ⁱ⁻¹+TRUᵢ₋₁) (1)

In the equation (1), the variant i is a positive integer, the variant m is a positive integer, the variant AGₘⁱ represents the i^{th} resource waste in the m^{th} candidate resource arrangement order, the variant nᵢ represents the end position corresponding to the latter user equipment of the two adjacent user equipments, the variant k₀ⁱ represents the additional delay corresponding to the latter user equipment of the two adjacent user equipments, the variant nᵢ₋₁ represents the end position corresponding to the former user equipment of the two adjacent user equipments, the variant k₀ⁱ⁻¹ represents the additional delay corresponding to the former user equipment of the two adjacent user equipments, the variant TRUᵢ₋₁ represents the resource demand corresponding to the former user equipment of the two adjacent user equipments, and the variant d represents the basic delay.

For comprehension, the candidate resource arrangement order 26 is described in detail as an example. For the first user equipment (i.e., the user equipment U1) in the candidate resource arrangement order 26, the processor 23 selects the smallest value that can satisfy the following requirement from the preset group as the additional delay of the user equipment U1: a value obtained by summing up the end position of the user equipment U1 in the downlink control channel 22, the basic delay, and the additional delay has to fall within the downlink shared channel 24. For the candidate resource arrangement order 26, the processor 23 further calculates the resource waste between the adjacent user equipments U1 and U4, the resource waste between the adjacent user equipments U4 and U2, and the resource waste between the adjacent user equipments U2 and U3.

For the resource waste between the user equipments U1 and U4, the processor 23 calculates the end position of the user equipment U1 in the downlink shared channel 24 according to the end position of the user equipment U1 in the downlink control channel 22, the basic delay, the additional delay of the user equipment U1, and the resource demand of the user equipment U1 (i.e., the resource demand of the former user equipment of the user equipment U1 and U4), calculates the start position of the user equipment U4 in the downlink shared channel 24 according to the end position of the user equipment U4 in the downlink control channel 22, the basic delay, and the additional delay of the user equipment U4, and then obtains the resource waste between the user equipments U1 and the U4 by subtracting the end position of the user equipment U1 in the downlink shared channel 24 from the start position of the user equipment U4 in the downlink shared channel 24. It shall be noted that during the process of calculating the resource waste between the user equipments U1 and U4, the processor 23 will select the smallest value that can make the resource waste not smaller than 0 from the preset group as the additional delay of the user equipment U4. The processor 23 will adopt the same principle to calculate the resource waste between the adjacent user equipments U4 and U2 as well as the resource waste between the adjacent user equipments U2 and U3. The details will not be further described herein.

Each of the candidate resource arrangement orders corresponds to a total resource waste, wherein each of the total resource wastes is a sum of the resource wastes of the corresponding candidate resource arrangement orders. Taking the candidate resource arrangement order 26 as an example, the total resource waste corresponding to the candidate resource arrangement order 26 is the sum of the resource waste between the adjacent user equipments U1 and U4, the resource waste between the adjacent user equipments U4 and U2, and the resource waste between the adjacent user equipments U2 and U3. The processor 23 then selects the candidate resource arrangement order corresponding to the minimum total resource waste as a selected resource arrangement order.

In some embodiments, in order to accelerate the computation, the processor 23 records the resource wastes in a plurality of matrixes, wherein the candidate resource arrangement orders corresponding to the resource wastes in the same matrix start from the same user equipment. For comprehension, please refer to FIG. 2D for the resource wastes corresponding to the six candidate resource arrangement orders starting from the user equipment U1. Specifically, the value of the element at the i^{th} row and the j^{th} column in FIG. 2D is the resource waste between the i^{th} user equipment and the j^{th} user equipment, wherein the i^{th} user equipment and the j^{th} user equipment are adjacent, the i^{th} user equipment is arranged in front of the j^{th} user equipment, and the variants i and j are positive integers. Taking the candidate resource arrangement order 26 as an example, the resource waste between the adjacent user equipment U1 and U4 is 2 (as shown by the element at the 1^{st} row and the 4^{th} column in FIG. 2D), the resource waste between the adjacent user equipment U4 and U2 is 1 (as shown by the element at the 4^{th} row and the 2^{nd} column in FIG. 2D), and the resource waste between the adjacent user equipment U2 and U3 is 2 (as shown by the element at the 2^{nd} row and the 3^{rd} column in FIG. 2D).

Please note that since FIG. 2D depicts the resource wastes corresponding to the six candidate resource arrangement orders starting from the user equipment U1, there is no route to the user equipment U1 from the other user equipments U2, U3, and U4. Hence, the resource wastes between two adjacent user equipments where the user equipment U1 is the latter user equipment are all set to be infinite. Additionally, since there is no route from a user equipment to itself, the resource waste between a user equipment and itself is set to be infinite (as shown by the diagonal elements in FIG. 2D).

Then, the processor 23 performs a plurality of operations on each of the matrixes to select a temporary resource arrangement order from the candidate resource arrangement orders corresponding to each matrix. The temporary resource arrangement order of one matrix is the candidate resource arrangement order having the smallest total resource waste among the candidate resource arrangement orders of that matrix. Specifically, the processor 23 performs the following operations (a)-(e) on each of the matrixes.

Operation (a): for each row of the matrix, subtracting the minimum value in the row from every element in the same row. Taking FIG. 2D as an example, the minimum values in the 1^{st} row to the 4^{th} row in the matrix are 2, 2, 1, and 1 respectively. For each row of the matrix, the processor 23 subtracts the minimum value in the row from every element in the same row, which results in the matrix as shown in FIG. 2E.

Operation (b): for each column of the matrix derived from the operation (a) except the column whose values are all infinite, subtracting the minimum value in the column from every element in the same column. Taking FIG. 2E as an example, the minimum values in the 2^{nd} row to the 4^{th} row in the matrix are all 0, and the matrix obtained after performing the operation (b) is shown in FIG. 2F.

Operation (c): examining whether the elements having values of 0 in the matrix cover every row and every column except the column whose values are all infinite. If the examination result of the operation (c) is negative, the processor 23 will perform the operations (a) and (b) again. If the examination result of the operation (c) is positive, the processor 23 will execute the operation (d).

Operation (d): examining whether the elements having a value of 0 at the i^{th} row and the j^{th} column except the column whose values are all infinite in the matrix is unique. If the examination result of the operation (d) is negative, for the candidate resource arrangement order represented by these zeros, the processor 23 will set the column corresponding to the first user equipment and the row corresponding to the last user equipment to be infinite and then perform the operation (d) again. If the examination result of the operation (d) is positive, the processor 23 will execute operation (e). Taking FIG. 2F as an example, the elements having a value of 0 in the j^{th} column in the matrix is not unique. The candidate resource arrangement order represented by the zeros shown in FIG. 2F is the user equipment U1, the user equipment U4, the user equipment U2, and the user equipment U3 in sequence. The processor 23 sets the column corresponding to the first user equipment (i.e., the 1^{st} column) and the row corresponding to the last user equipment (i.e., the 3^{rd} row) in this candidate resource arrangement order set to be infinite as shown in FIG. 2G.

Operation (e): deciding the temporary resource arrangement order of the matrix (i.e., the candidate resource arrangement order represented by the elements having values of 0) based on the elements having values of 0 at the i^{th} row and the j^{th} column (except the column whose values are all infinite). Taking FIG. 2G as an example, the processor 23 selects the candidate resource arrangement order 26 (i.e., arranged in the order of the user equipment U1, the user equipment U4, the user equipment U2, and the user equipment U3) as the temporary resource arrangement order of this matrix based on the elements having values of 0. As mentioned, the temporary resource arrangement order is the candidate resource arrangement order having the smallest total resource waste among the candidate resource arrangement orders corresponding to the matrix.

After selecting the temporary resource arrangement order of each matrix, the processor 23 selects a selected resource arrangement order to be adopted (e.g., selects the temporary resource arrangement order corresponding to the minimum total resource waste) from the temporary resource arrangement orders according to the total resource wastes corresponding to these temporary resource arrangement orders.

After selecting the selected resource arrangement order, the processor 23 may transmit the data of the user equipments U1, U2, U3, and U4 according to the selected resource arrangement order. Specifically, the processor 23 may calculate the transmission position of each of the user equipments U1, U2, U3, and U4 in the downlink shared channel 24 according to the basic delay, the end position of each of the user equipments U1, U2, U3, and U4 in the downlink control channel 22, and the additional delay of each of the user equipments U1, U2, U3, and U4. The transceiver 21 then transmits the data of each of the user equipments U1, U2, U3, and U4 at the transmission position of each of the user equipments U1, U2, U3, and U4.

Here it is assumed that the processor 23 selects the candidate resource arrangement order 26 (i.e., in the order of the user equipment U1, the user equipment U4, the user equipment U2, and the user equipment U3) as the selected resource arrangement order. The processor 23 takes the value (i.e., r₁+d+k₀^{1′}) obtained by summing up the end position r₁ of the user equipment U1 in the downlink control channel 22, the basic delay d (i.e., a value of 5), and the additional delay k₀¹′ as the start position t₁ of resource transmission of the user equipment U1 in the downlink shared channel 24, and then arranges the transmission resource Q₁ according to the start position t₁ and the resource demand (i.e., 8 resource units) of the user equipment U1 as shown in FIG. 2B.

Based on the same operation principle, the processor 23 calculates a start position t₄ of resource transmission of the user equipment U4 in the downlink shared channel 24 (i.e., t₄=r₄+d+k₀^{4′}) and then arranges the transmission resource Q4 according to the start position t₄ and the resource demand (i.e., 4 resource units) of the user equipment U4 as shown in FIG. 2B. Based on the same operation principle, the processor 23 calculates a start position t₂ of resource transmission of the user equipment U2 in the downlink shared channel 24 (i.e., t₂=r₂+d+k₀^{2′}) and then arranges the transmission resource Q2 according to the start position t₂ and the resource demand (i.e., 4 resource units) of the user equipment U2 as shown in FIG. 2B. Based on the same operation principle, the processor 23 calculates a start position t₃ of resource transmission of the user equipment U3 in the downlink shared channel 24 (i.e., t₃=r₃+d+k₀^{3′}) and then arranges the transmission resource Q3 according to the start position t₃ and the resource demand (i.e., 4 resource units) of the user equipment U3 as shown in FIG. 2B. The transceiver 21 then transmits the data of the user equipments U1, U2, U3, and U4 at the transmission positions beginning from the starting positions t₁, t₂, t₃, and t₄ of the user equipments U1, U2, U3, and U4 respectively.

According to the above description, the IoT base station 2 will evaluate the total resource waste of each of the plurality of candidate resource arrangement orders of the user equipments U1, U2, U3, and U4 in the downlink shared channel 24 before arranging the transmission resources of the downlink shared channel 24 for the user equipments U1, U2, U3, and U4. During the evaluation of each of the candidate resource arrangement orders, the IoT base station 2 will individually determine the additional delay for each of the user equipments U1, U2, U3, and U4 which minimizes the resource wastes of the candidate resource arrangement order. The IoT base station 2 then selects the candidate resource arrangement order corresponding to the minimum total resource waste as the selected resource arrangement order to be adopted. By considering the total resource waste of each of the candidate resource arrangement orders, the IoT base station 2 can sufficiently utilize the resources of the downlink shared channel 24. Hence, the amount of resource waste can be reduced and the probability that the transmission resource demands of all the user equipments cannot be arranged within one downlink processing period can be decreased.

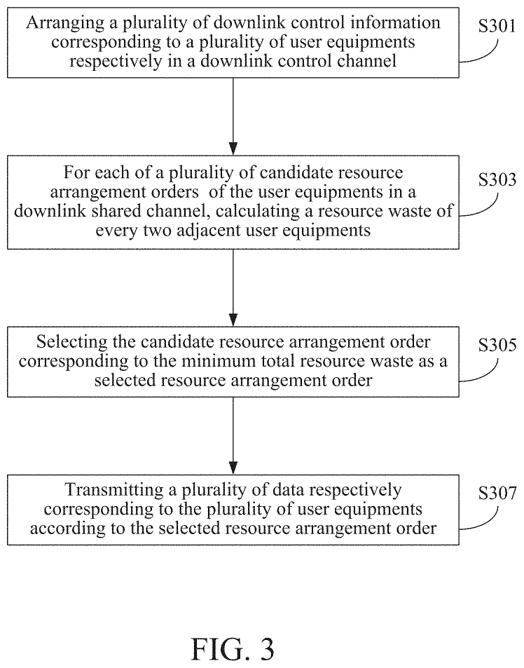

A second embodiment of the present invention is a resource arrangement method and a flowchart of which is depicted in FIG. 3. The resource arrangement method is adapted for use in an IoT base station, e.g., the IoT base station 2 described in the first embodiment. The resource arrangement method executes steps S301 to S307.

In step S301, the IoT base station arranges a plurality of downlink control information corresponding to a plurality of user equipments respectively in a downlink control channel. Each of the downlink control information corresponds to an end position and each of the user equipments has a resource demand.

In some embodiments, the resource arrangement method further comprises a step of calculating the resource demand. Specifically, in these embodiments, each of the user equipments has a demand number of resource units, each of the downlink control information of the user equipments defines a number of repetitions, and the step calculates, by the IoT base station, the resource demand of each of the user equipments according to the demand number of resource units and the number of repetitions corresponding to the user equipment.

In step S303, for each of a plurality of candidate resource arrangement orders (e.g., the plurality of candidate resource arrangement orders formed by the user equipments U1, U2, U3, and U4 depicted in FIG. 2C) of the plurality of user equipments in a downlink shared channel, the IoT base station calculates a resource waste of every two adjacent user equipments. Taking the candidate resource arrangement order 26 of FIG. 2C as an example, the step S303 calculates the resource waste between the adjacent user equipments U1 and U4, the resource waste between the adjacent user equipments U4 and U2, and the resource waste between the adjacent user equipments U2 and U3.

Specifically, each of the resource wastes calculated by the step S303 is calculated based on a basic delay, the two end positions of the two user equipments corresponding to the resource waste, an additional delay of each of the two user equipments corresponding to the resource waste, and the resource demand of the former user equipment of the two user equipments corresponding to the resource waste. Taking the resource waste between the adjacent user equipments U1 and U4 in the candidate resource arrangement order 26 depicted in FIG. 2C as an example, the step S303 calculates the end position of the user equipment U1 in the downlink shared channel 24 according to the end position of the user equipment U1 in the downlink control channel 22, the basic delay, the additional delay of the user equipment U1, and the resource demand of the user equipment U1, calculates the start position of the user equipment U4 in the downlink shared channel 24 according to the end position of the user equipment U4 in the downlink control channel 22, the basic delay, and the additional delay of the user equipment U4, and obtains the resource waste between the user equipments U1 and U4 by subtracting the end position of the user equipment U1 in the downlink shared channel 24 from the start position of the user equipment U4 in the downlink shared channel 24.

In some embodiments, the step S303 may calculate each of the resource wastes according to the aforesaid equation (1). In these embodiments, the step S303 comprises a step of selecting the variant k₀ⁱ from a preset group (specifically, the preset group comprises specific values, including 0, 4, 8, 16, 32, 64, 128, 256, . . . ) which makes the variant AGₘⁱ not smaller than 0 when calculating each of the resource wastes.

Each of the candidate resource arrangement orders corresponds to a total resource waste, wherein each of the total resource wastes is a sum of the resource wastes of the corresponding candidate resource arrangement order. In step S305, the IoT base station selects the candidate resource arrangement order corresponding to the minimum total resource waste as a selected resource arrangement order.

In some embodiments, in order to accelerate the computation, the step S305 may be accomplished by matrix operations. Specifically, the step S305 may enable the IoT base station to record the resource wastes with a plurality of matrixes. It shall be appreciated that the candidate resource arrangement orders corresponding to the resource wastes in the same matrix start from the same user equipment (e.g., the matrix shown in FIG. 2D records the resource wastes corresponding to the six candidate resource arrangement orders starting from the user equipment U1.) In the step S305, the IoT base station further selects a temporary resource arrangement order for each of the matrix from the corresponding candidate resource arrangement orders by performing a plurality of operations on each of the matrix. It shall be appreciated that the temporary resource arrangement order of one matrix is the candidate resource arrangement order having the smallest total resource waste among among the candidate resource arrangement orders of that matrix. Thereafter, the step S305 selects the selected resource arrangement order from the temporary resource arrangement orders according to the total resource wastes corresponding to the temporary resource arrangement orders.

Afterward, in step S307, the IoT base station transmits a plurality of data respectively corresponding to the plurality of user equipments according to the selected resource arrangement order. Specifically, the step S307 may comprise a step of calculating, by the IoT base station, a transmission position of each of the user equipments according to the basic delay, the end position of the user equipment, and the additional delay of the user equipment. The step S307 further comprises another step of transmitting, by the IoT base station, the data of each of the user equipments at the transmission position of the user equipment.

It shall be appreciated that, the IoT base station may adopt various IoT communication standards, e.g., a Narrow Band Internet of Things (NB-IoT) standard specified by the 3^{rd} Generation Partnership Project Agreement (3GPP), and a Massive Machine-Type Communication (Massive MTC) standard in a 5^{th} generation of mobile communication system. If the IoT base station adopts the NB-IoT standard, the downlink control channel is a narrow band physical downlink control channel (NPDCCH) and the downlink shared channel is a narrow band physical downlink shared channel (NPDSCH).

From the above description of the embodiments, the resource arrangement technology (including the IoT base station and the resource arrangement method thereof) provided by the present invention will evaluate the total resource waste of each of the candidate resource arrangement orders of the user equipments in the downlink shared channel before arranging the transmission resources of the downlink shared channel for the user equipments. During the evaluation of each of the candidate resource arrangement orders, the resource arrangement technology provided by the present invention will individually determine the additional delay for each user equipment which minimize the resource wastes of the candidate resource arrangement order. Then, the resource arrangement technology provided by the present invention selects the candidate resource arrangement order corresponding to the minimum total resource waste as the selected resource arrangement order to be adopted. By considering the total resource waste of each of the candidate resource arrangement orders, the resource arrangement technology provided by the present invention can sufficiently use the resources of the downlink shared channel Hence, the amount of resource waste can be reduced and the probability that the transmission resource demands of all the user equipments cannot be arranged within one downlink processing period can be decreased.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An internet of things (IoT) base station, comprising:
a transceiver; and
a processor, being electrically connected to the transceiver, and configured to arrange a plurality of downlink control information corresponding to a plurality of user equipments respectively in a downlink control channel, each of the downlink control information corresponding to an end position, and each of the user equipments having a resource demand;
wherein for each of a plurality of candidate resource arrangement orders of the plurality of user equipments in a downlink shared channel, the processor further calculates a resource waste of every two adjacent user equipments, and each of the resource wastes is calculated based on a basic delay, the two end positions of the two user equipments corresponding to the resource waste, an additional delay of each of the two user equipments corresponding to the resource waste, and the resource demand of the former user equipment of the two user equipments corresponding to the resource waste,
wherein each of the candidate resource arrangement orders corresponds to a total resource waste and each of the total resource wastes is a sum of the resource wastes of the corresponding candidate resource arrangement order,
wherein the processor further selects the candidate resource arrangement order corresponding to the minimum total resource waste as a selected resource arrangement order,
wherein the transceiver further transmits a plurality of data respectively corresponding to the plurality of user equipments according to the selected resource arrangement order.

2. The IoT base station of claim 1, wherein each of the user equipments has a demand number of resource units, each of the downlink control information defines a number of repetitions, and the processor further calculates the resource demand of each of the user equipments according to the demand number of resource units and the number of repetitions corresponding to the user equipment.

3. The IoT base station of claim 1, wherein the processor calculates each of the resource wastes according to the following equation:
AGₘⁱ=(nᵢ+d+k₀ⁱ)−(nᵢ₋₁+d+k₀ⁱ⁻¹+TRUᵢ₋₁),
wherein the variant i is a positive integer, the variant m is a positive integer, the variant AGₘⁱ represents the i^{th} resource waste in the m^{th} candidate resource arrangement order, the variant nᵢ represents the end position corresponding to the latter user equipment of the two adjacent user equipments, the variant k₀ⁱ represents the additional delay corresponding to the latter user equipment of the two adjacent user equipments, the variant n represents the end position corresponding to the former user equipment of the two adjacent user equipments, the variant k₀ⁱ⁻¹ represents the additional delay corresponding to the former user equipment of the two adjacent user equipments, the variant TRUᵢ₋₁ represents the resource demand corresponding to the former user equipment of the two adjacent user equipments, and the variant d represents the basic delay.

4. The IoT base station of claim 3, wherein the processor selects the variant k₀ⁱ which makes the variant AGₘⁱ not smaller than 0 from a preset group when calculating each of the resource wastes.

5. The IoT base station of claim 1, wherein the processor records the resource wastes in a plurality of matrixes, and the candidate resource arrangement orders corresponding to the resource wastes in the same matrix start from the same user equipment.

6. The IoT base station of claim 5, wherein the processor further selects a temporary resource arrangement order from the candidate resource arrangement orders corresponding to each of the matrixes by performing a plurality of operations on each of the matrixes, and the processor further selects the selected resource arrangement order from the temporary resource arrangement orders according to the total resource wastes corresponding to the temporary resource arrangement orders.

7. The IoT base station of claim 1, wherein the processor further calculates a transmission position of each of the user equipments according to the basic delay, the end position of the corresponding user equipment, and the additional delay of the corresponding user equipment, and the transceiver transmits the data of each of the user equipments at the corresponding transmission position.

8. The IoT base station of claim 1, wherein the IoT base station conforms to a narrow band Internet of Things (NB-IoT) standard, the downlink control channel is a narrow band physical downlink control channel (NPDCCH) specified by the NB-IoT standard, and the downlink shared channel is a narrow band physical downlink shared channel (NPDSCH) specified by the NB-IoT standard.

9. The IoT base station of claim 1, wherein the IoT base station conforms to a massive machine-type communication (massive MTC) standard of a 5^{th} generation of mobile network.

10. A resource arrangement method for use in an internet of things (IoT) base station, the method comprising:
arranging a plurality of downlink control information corresponding to a plurality of user equipments respectively in a downlink control channel, wherein each of the downlink control information corresponds to an end position and each of the user equipments has a resource demand;
performing the following operation for each of a plurality of candidate resource arrangement orders of the plurality of user equipments in a downlink shared channel:
calculating a resource waste of every two adjacent user equipments, wherein each of the resource wastes is calculated based on a basic delay, the two end positions of the two user equipments corresponding to the resource waste, an additional delay of each of the two user equipments corresponding to the resource waste, and the resource demand of the former user equipment of the two user equipments corresponding to the resource waste, each of the candidate resource arrangement orders corresponds to a total resource waste, and each of the total resource wastes is a sum of the resource wastes of the corresponding candidate resource arrangement order;
selecting the candidate resource arrangement order corresponding to the minimum total resource waste as a selected resource arrangement order; and
transmitting a plurality of data respectively corresponding to the plurality of user equipments according to the selected resource arrangement order.

11. The resource arrangement method of claim 10, wherein each of the user equipments has a demand number of resource units, each of the downlink control information defines a number of repetitions, and the resource arrangement method further comprising:
calculating the resource demand of each of the user equipments according to the demand number of resource units and the number of repetitions corresponding to the user equipment.

12. The resource arrangement method of claim 10, wherein each of the resource wastes is calculated according to the following equation:
AGₘⁱ=(nᵢ+d+k₀ⁱ)−(nᵢ₋₁+d+k₀ⁱ⁻¹+TRUᵢ₋₁),
wherein the variant i is a positive integer, the variant m is a positive integer, the variant AGₘⁱ represents the i^{th} resource waste in the m^{th} candidate resource arrangement order, the variant nᵢ represents the end position corresponding to the latter user equipment of the two adjacent user equipments, the variant k₀ⁱ represents the additional delay corresponding to the latter user equipment of the two adjacent user equipments, the variant nᵢ₋₁ represents the end position corresponding to the former user equipment of the two adjacent user equipments, the variant k₀ⁱ⁻¹ represents the additional delay corresponding to the former user equipment of the two adjacent user equipments, the variant TRUᵢ₋₁ represents the resource demand corresponding to the former user equipment of the two adjacent user equipments, and the variant d represents the basic delay.

13. The resource arrangement method of claim 12, wherein the step of calculating each of the resource wastes comprises a step of selecting the variant k₀ⁱ which makes the variant AGₘⁱ not smaller than 0 from a preset group.

14. The resource arrangement method of claim 10, wherein the step of selecting the candidate resource arrangement order corresponding to the minimum total resource waste as the selected resource arrangement order comprises:
recording the resource wastes in a plurality of matrixes, wherein the candidate resource arrangement orders corresponding to the resource wastes in the same matrix start from the same user equipment.

15. The resource arrangement method of claim 14, wherein the step of selecting the candidate resource arrangement order corresponding to the minimum total resource waste as the selected resource arrangement order further comprises:
selecting a temporary resource arrangement order for each of the matrixes from the corresponding candidate resource arrangement orders by performing a plurality of operations on each of the matrix; and
selecting the selected resource arrangement order from the temporary resource arrangement orders according to the total resource wastes corresponding to the temporary resource arrangement orders.

16. The resource arrangement method of claim 10, wherein the step of transmitting the plurality of data respectively corresponding to the plurality of user equipments according to the selected resource arrangement order comprises:
calculating a transmission position of each of the user equipments according to the basic delay, the end position of the corresponding user equipment, and the additional delay of the corresponding user equipment; and
transmitting the data of each of the user equipments at the corresponding transmission position.

17. The resource arrangement method of claim 10, wherein the IoT base station conforms to a narrow band Internet of Things (NB-IoT) standard, the downlink control channel is a narrow band physical downlink control channel (NPDCCH) specified by the NB-IoT standard, and the downlink shared channel is a narrow band physical downlink shared channel (NPDSCH) specified by the NB-IoT standard.

18. The resource arrangement method of claim 10, wherein the IoT base station conforms to a massive machine-type communication (massive MTC) standard of a 5^{th} generation of mobile network.
